(19) United States
(12) Patent Application Publication
(10) Pub. No.: US 2011/0170693 A1
(43) Pub. Date: Jul. 14, 2011

(54) STATELESS METHOD AND SYSTEM FOR PROVIDING LOCATION INFORMATION OF TARGET DEVICE

(75) Inventors: Martin Wyville THOMSON, Keiraville (AU); Anthony James WINTERBOTTOM, Gwynneville (AU)

(73) Assignee: ANDREW LLC, Hickory, NC (US)

(21) Appl. No.: 12/891,971

(22) Filed: Sep. 28, 2010

Related U.S. Application Data
(60) Provisional application No. 61/294,591, filed on Jan. 13, 2010.

(51) Int. Cl. H04L 9/00; G06F 15/16; G06F 21/00

(52) U.S. Cl. 380/277; 709/219; 726/1

(57) ABSTRACT

A method of providing a location of a target device includes receiving a first location reference request from the target device at a first location server, generating a first location reference in response to the first request, and including the first location reference in a second location reference request to a second location server. The second location server generates a second location reference in response to the second request, where the second location reference is stateless and refers to the first location reference. The second location reference is received from the second location server, and provided to the target device to be provided to an application requesting location information of the target device from the second location server. The stateless second location reference includes information necessary for the second location server to serve a request for the location of the target device without maintaining state specific to the location reference.

### PRIORITY STATEMENT

This application claims priority from Provisional Patent Application No. 61/294,591, filed Jan. 13, 2010, in the United States Patent and Trademark Office, the disclosure of which is hereby incorporated by reference.

### BACKGROUND AND SUMMARY

Conventional wireless communication services, as well as Internet Protocol services, may include the feature of determining geographic locations of devices. Whether the device is mobile or fixed in their network attachments, they are collectively referred to as “target devices.” For example, one type of location based service is an E-911 emergency service responsive to “911” calls from target devices. Such emergency services may include estimating latitude and longitude of the target device, which is particularly important when a distressed caller is otherwise unable to provide their present position.

Locations of target devices may be determined by a location server, such as a location information server (LIS), operating in the corresponding network. A LIS may determine the location of a target device using positioning measurements from a global navigation satellite system (GNSS) provided by the target device, using terrestrial or network-oriented measurements (such as signal strength, arrival time, timing advance, wire map, etc.), or using a combination of techniques, for example. The location information may be retrieved from the LIS using network specific protocols, either directly or indirectly, e.g., through a uniform resource identifier (URI) generated by the LIS. In IP networks, the LIS may determine the location of an IP terminal based on network topology, such as known locations of access points, for example. In a wired network, such as Ethernet or Digital Subscriber Line (DSL), a wiremap may be used for location determination based on tracing data through network access points to find the particular port to which the IP device is connected.

Generally, a location based service may be implemented by an application accessed over the Internet or other packet switching network, where the application requires “trustworthy” location information with respect to the target device. Conventional approaches to providing trustworthy location information over the Internet include “signing” the location information according to various methods that allow the location information to be attributed to a specific target device at a specific point in time. Currently, there is no standardization of such methods by the Internet community.

For example, a large enterprise, such as a university, government entity, corporation or the like, may provide a localized enterprise network, which is able to determine the location of target devices within the corresponding campus or facility to a relatively high degree of accuracy using an enterprise LIS. However, because it is an enterprise network, the location information provided by the LIS may not be inherently trusted by the Internet application requesting the location information. Conversely, a carrier may provide backhaul infrastructure to the enterprise over a carrier network, using a carrier LIS, which typically would be recognizable and trusted by the Internet application. However, the carrier network would be unable to provide location information indicating the position of the target device within the enterprise network, or would otherwise be unable to provide location information to the same degree of accuracy. For example, an enterprise network may be able to provide locations with reference to specific buildings located on a campus and/or floors within a building.

In a representative embodiment, a method provides a location of a target device. The method includes receiving a first location reference request from the target device at a first location server; generating a first location reference in response to the first request; and including the first location reference in a second location reference request to a second location server. The second location server generates a stateless second location reference in response to the second request, the second location reference being embedded in the second location reference, where the stateless second location reference includes information necessary for the second location server to serve a request for the location of the target device without maintaining state specific to the location reference. The second location reference is received from the second location server, and provided to the target device. The target device provides the second location reference to an application requesting location information of the target device from the second location server.

In another representative embodiment, a method provides a location of a target device to an application implementing a location based service. The method includes receiving a request for a location of the target device from the application at a second location server, the request including a stateless second location reference that includes an embedded first location reference identifying the target device and a first location server that generated the location reference. The method further includes sending a request to the first location server identified in the first location reference for the location of the target device, the request including the first location reference, which is used by the first location server for identifying the target device and determining the location of the target device. The determined location of the target device is received from the first location server, and provided to the application.

In another representative embodiment, a system is provided for retrieving a location of a target device. The system includes an asserting location information server (LIS) in an enterprise network and a validating LIS in a carrier network. The asserting LIS provides a first location URI to a validating LIS in response to a request for a location URI from a target device in the enterprise network, receives a stateless second location URI from the validating LIS including the first location URI, and provides the second location URI to the target device, wherein the target device sends the second location URI to an Internet application providing a location based service to the target device. The validating LIS receives the second location URI from the Internet application in a request for the location of the target device, extracts the first location URI from the second location URI, provides the first location URI in a request to the asserting LIS for the location of the target device, receives the location of the target device determined by the asserting LIS, and provides the received location of the target device to the Internet application. The asserting LIS does not have a trust relationship with the Internet application.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a functional block diagram illustrating a system for locating target devices in a communication network, according to a representative embodiment.

FIG. 2 is a flowchart illustrating a method implemented by a location server in a first network for locating target devices, according to a representative embodiment.

FIG. 3 is a flowchart illustrating a method implemented by a location server in a second network for locating target devices in the first network, according to a representative embodiment.

FIG. 4 is a functional block diagram illustrating a system for locating target devices in a communication network using a stateless implementation, according to a representative embodiment.

FIG. 5 is a flowchart illustrating a method implemented by a location server in a first network for locating target devices using a stateless implementation, according to a representative embodiment.

FIG. 6 is a flowchart illustrating a method implemented by a location server in a second network for locating target devices in the first network using a stateless implementation, according to a representative embodiment.

FIG. 7 is a functional block diagram showing an illustrative location server for locating a target device, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings.

In various embodiments, trusted location information regarding the geodetic or civic position of a target device is provided to a location based service application across trust domains, transparently to already standardized mechanisms. A location reference, such as a location URI, is generated or obtained by an enterprise location server and used to instantiate carrier trustworthiness to the location information determined by the enterprise location server, e.g., using established methods of location information transfer.

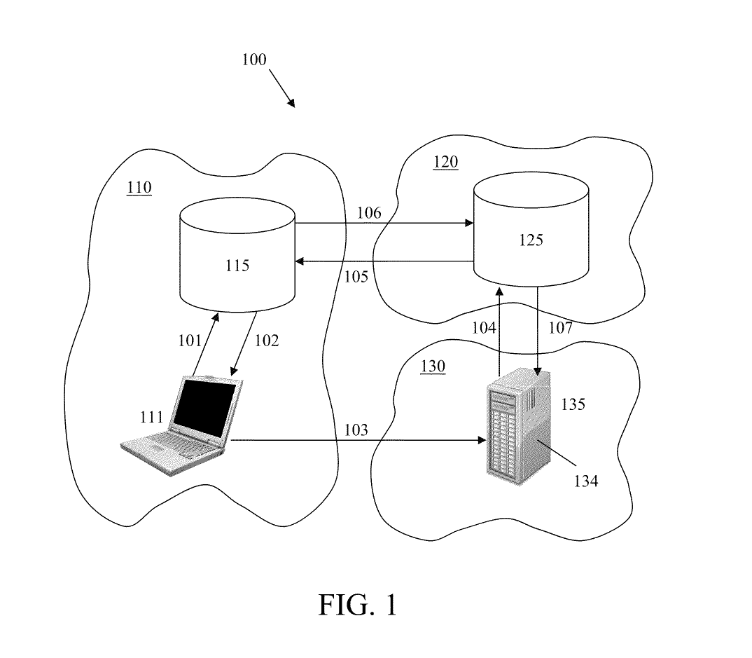

FIG. 1 is a functional block diagram illustrating a system for locating target devices in a communication network, according to a representative embodiment.

Referring to FIG. 1, telecommunications system 100 includes multiple networks serviced by corresponding location servers, indicated by first network 110 serviced by first location server 115 and second network 120 serviced by second location server 125. Representative target device 111 is shown residing in the first network 110. The target device 111 may be any type of device or terminal, configured for communicating through the telecommunications system 100, such as a cellular phone, a VoIP phone, a laptop computer, a personal digital assistant (PDA), a gaming device, television, appliance (e.g., refrigerator), or the like.

The target device 111 is depicted accessing a location based service, provided by application 134 running on application server 135 in third network 130. For example, the third network 130 may be the Internet, in which case the application server 135 may be a web server accessible by the target device 111 through any of a variety of wired or wireless modems and/or access points, as would be apparent to one of ordinary skill in the art. In various embodiments, the third network 130 may include other types of communication networks, such as Ethernet or private corporate network, without departing from the scope of the present teachings.

In the depicted embodiment, the first network 110 may be an enterprise network, for example, corresponding to a particular facility, such as a campus, a multiple story building or the like. The first network 110 includes the first location server 115, which may be referred to as an “asserting LIS,” for example. The second network 120 may be a carrier network, for example, corresponding to a wide area network (WAN) or the like. The second network 120 includes the second location server 125, which may be referred to as a “validating LIS,” for example.

Each of the first and second location servers 115 and 125 are configured to implement any of various types of location determination algorithms or processes, without departing from the scope of the present teachings, for determining locations of target devices, such as target device 111, operating within one or both networks. Examples of location determination processes may use satellite and/or terrestrial positioning systems to determine the location of the target device 111 based on satellite measurements, terrestrial measurements or combinations thereof for position calculation, which may include trilateration techniques. Satellite positioning systems, such as GNSS networks, may be any system configured to provide geographic locations of receivers, e.g., housed in the target device 111, using a constellation of satellites, such as the Global Positioning System (GPS), Global Navigation Satellite System (GLONASS), Galileo and COMPASS Navigation Satellite System (BeiDou), and the like. Terrestrial positioning systems may be based on any type of range measurements, such as round-trip time (RTT) measurements (e.g., in a UMTS network), uplink-time difference of arrival (U-TDOA) or timing advance (TA) measurements (e.g., in a GSM network), enhanced observed time difference (E-OTD) measurements, angle of arrival (AoA) measurements, power of arrival (POA) measurements, WiFi measurements, DTV signals, wiremap and packet tracing techniques, and the like. Of course, the method(s) which the first and second location servers 115 and 125 are configured to use for determining the location of the target device 111 may vary to provide unique benefits for any particular situation or to meet application specific design requirements of various implementations, as would be apparent to one of ordinary skill in the art.

In addition, due to the localized nature of the first network 110, the location determination processes implemented by the first location server 115 may include using access points, sensors or the like, located throughout the facility serviced by the first network 110. For example, the target device 111 may connect with resources of the first network 110, including the first location server 115, through a wired or wireless local area network (LAN), such as WiFi (IEEE standard 802.11) or WiMax (IEEE standard 802.16) networks, for example. The location of the target device 111 may then be determined, in part, based on a previously stored location of an access point used by the target device 111. Where the access point is wireless in nature, more precise locations within the first network 110 may be attained using sensors, signal strength measurements, triangulation among different access points and various other techniques, as would be apparent to one of ordinary skill in the art. Thus, location determination by the first location server 115 in response to a location request from the target device 111 may be particularly accurate, e.g., as compared to the second location server 125, which may only be able to provide accuracy to the level of the complete coverage area of first network 110.

However, it is understood that the infrastructure and techniques for communication between the target device 111 and the first location server 115 and/or the second location server 125 may vary without departing from the scope of the present teachings. For example, the first network 110 (and/or the second network 120) may include one or more IP routers configured to interface with the first location server 115. Further, the IP router may be configured to communicate with the application server 135 via one or more additional IP routers in the third network 130 and/or in a gateway and circuit switching network, for example.

For purposes of discussion, it is assumed that the first network 110 implements location services that are not trusted by an external application, such as representative application 134 running on application sever 135, while the second network 120 implements location services that are trusted by the application 134. In other words, there is no preexisting trust relationship between the application 134 and the first location server 115, but there is a preexisting trust relationship between the application 134 and the second location server 125. For example, the application server 135 may be a public safety access point (PSAP) associated with an emergency call center for answering calls to emergency numbers, including 911. Thus, the application 134 automatically initiates a location determination process in response to a call from the target device 111 by querying the (trusted) second location server 125, even though the target device 111 is in the first network 110 serviced by the (untrusted) first location server 115. This serving network arrangement is not visible to the application 134, as the location URI provided by target 111 denotes that the second location server 125 is to be used for acquiring the location of target 111.

According to various embodiments, the telecommunications system 100 provides a tandem trust relationship between the application server 135 and the first location server 115 through location server 125, so that the application server 135 may obtain location information with respect to the target device 111, even though location information provided directly by the location server 115 would otherwise be deemed untrustworthy. Various steps for establishing the tandem trust relationship and providing location information to the application server 135 are depicted in FIG. 1 by numbered arrows, according to a representative embodiment.

In the depicted embodiment, the target device 111, while residing in the first network 110, requests a location reference from the first location server 115 in step 101. The request may be in response to execution of a location based service by the target device 111. Alternatively, the target device 111 may initiate such a request generally, e.g., whenever connecting to the first network 110 or after being connected over a predetermined period of time, in anticipation of the possibility of needing this information. Alternatively, the request for the location reference for the target device 111 may be initiated by a client other than the target device 111. The first location server 115 returns the location reference to the target device 111 in step 102.

In accordance with various embodiments, the location reference includes at least the following three properties. First, the external domain to which the location reference is attributed is that of the second location server 125, which may be the carrier's or the infrastructure provider's LIS, as discussed above. That is, the location reference points to the second location server 125. Second, the location reference includes one or more parameters that enable the second location server 125 to identify the first location server 115. For example, identification parameters may include an IP address, a Media Access Control (MAC) address, a uniform resource locator (URL) or other unique identifier associated with the first location server 115. Third, the location reference includes one or more parameters that enable the first location server 115, when receiving the location URI from the second location server 125, to identify the target device 111 for which the location URI was originally created. For example, identification parameters may include an electronic serial number (ESN), an IP address, a MAC address or other unique identifier associated with the target device 111.

In various embodiments, the location reference may be a location URI, for example, having at least the three properties discussed above. However, any type of location reference or other identifying information having at least these properties may be incorporated, without departing from the scope of the present teachings. That is, the location reference need only provide enough information for the second server 125 to identify the first server 115, and a token that can be passed between the first server 115 and the second server 125 for the purpose of identifying the target device 111. For example, any minted token capable of identifying the source entity may be used. A digital signature over a nonce that identifies the target device 111 would likewise work, since the digital signature needs to include an indicator of who signed it, which in turn leads back to the signing party (e.g., the first server 115).

After receiving the location reference from the first location server 115, the target device 111 conveys the location reference to the application server 135, e.g., in reply to a request for the location reference by the application 134. Alternatively, the target device 111 may automatically provide the location reference to the application 134 upon initiating the corresponding location based service. The application 134 may be any location based service implemented by the application 134, without departing from the scope of the present application. For example, the application 134 may be configured to provide directions or to identify the nearest locations of various restaurants, gas stations, rest stops or the like.

In step 104, the application 134 requests the location of the target device 111 from the second location server 125 using the location reference provided by the target device 111. As stated above, application 134 considers the location service implemented second location server 125 a trusted service. In various embodiments, the application 134 does not specifically identify the first location server 115 using the location reference. Such information generally would not be useful to the application 134, since it does not consider the location service implemented by the first location server 115 a trusted service, and thus would not consider a response from location server 115 as valid.

The second location server 125 receives the request from the application server 135, and in response, uses the location reference to identify the first location server 115. This is necessary since the second location server 125 may be servicing location servers (e.g., asserting LISs) from more than one enterprise network, for example. The second location server 125 sends a location request to the identified first location server 115 in step 105 to query the location of the target device 111, using the location reference as the identity of the target device 111.

The first location server 115 receives the location request from the second location server 125, and uses the information provided by the location reference to identify the target device 111, e.g., from among multiple mobile devices operating within the first network 110. The first location server 115 then determines the location of the identified target device 111 by performing its associated location determination algorithm, discussed above. The determined location is provided to the second location server 125 in step 106. The second location server 125 then provides the determined location of the target device 111 to the application server 135 in step 107, which uses the determined location to complete execution of the application 134.

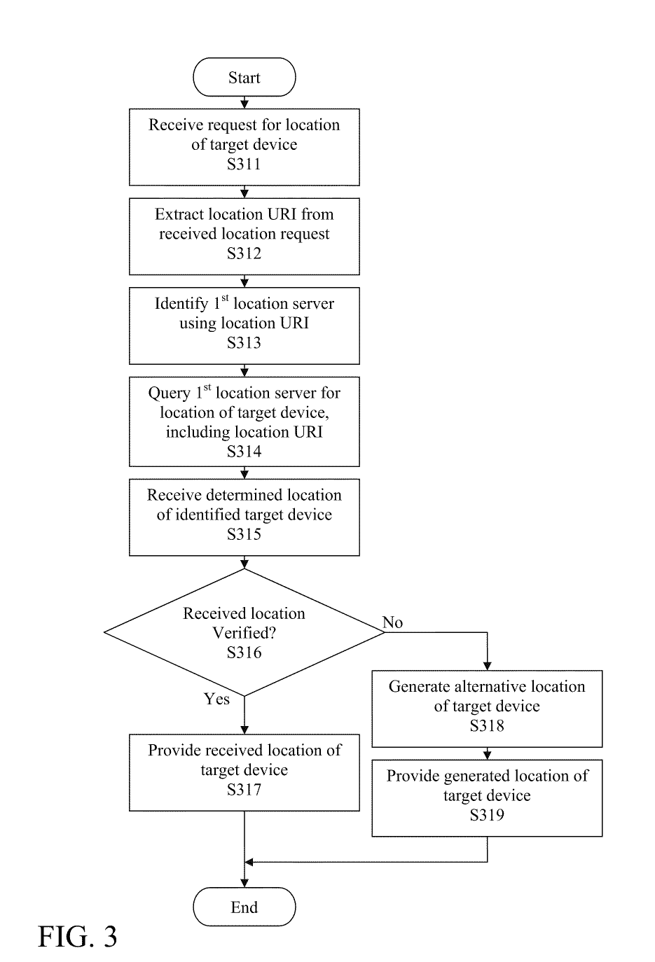

In various embodiments, the second location server 125 may first validate the location of the target device 111 before sending the location on to the application server 135, as discussed further with reference to FIG. 3, below. When the second location server 125 is unable to validate the location, it may separately determine the location of the identified target device 111 by performing its associated location determination algorithm, which is then provided to the application server 135 in step 107.

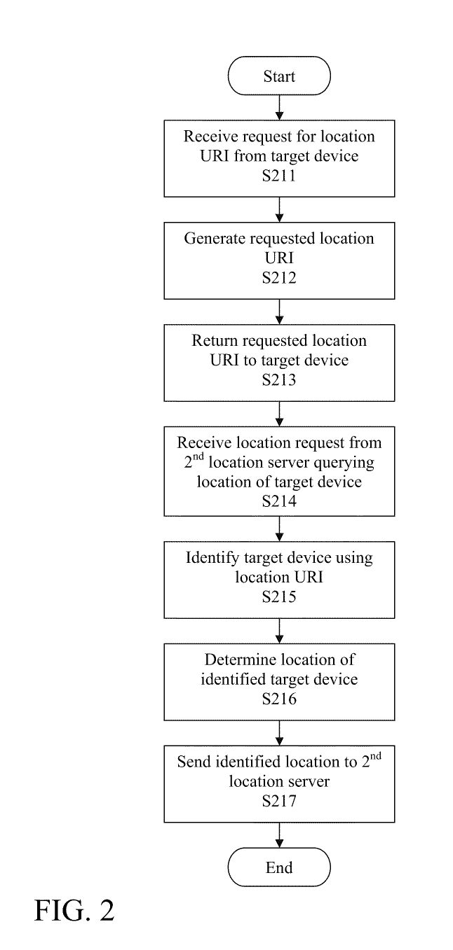

The location determination process using tandem trust relationships discussed above with reference to FIG. 1 may be implemented according to complementary algorithms executable by the first and second location servers 115 and 125, respectively. For example, FIG. 2 is a flowchart illustrating a method implemented by the first location server 115 in the first network 110 for locating the target device 111, and FIG. 3 is a flowchart illustrating a method implemented by the second location server 125 in the second network 120 for locating the target device 111, according to representative embodiments. For purposes of description, the location reference is assumed to be a location URI, although various other types of location reference may be incorporated, as discussed above.

Referring to FIG. 2, the first location server 115, e.g., the asserting LIS, receives a request for a location URI from the target device 111 in block S211, where the target device 111 is operating within the first network 110. The target device 111 has a MAC address and has been allocated a dynamic IP address in the first network 110. The request is received through the first network 110, which may be any type of wired or wireless IP network in the present example.

In response, the first location server 115 generates or otherwise obtains the requested location URI in block S212. As discussed above, the location URI is attributed to the external domain of the second location server 125 e.g., the validating LIS. Also, the location URI includes parameters that enable the second location server 125 to identify the first location server 115 and that enable the first location server 115 subsequently to identify the target device 111, respectively.

For example, the first location server 115 may identify the IP address of the target device 111 from the request received in block S211, and determine the MAC address of the target device 111 based on the IP address using any of a variety of determination techniques, as would be apparent to one of ordinary skill in the art. The first location server 115 may then create a unique token, which it uses as a key in its memory cache to point to the IP address and the MAC address of the target device 111. However, various other parameters for identifying the first location server 115 and/or the target device 111 may be included without departing from the scope of the present teachings. In addition, according to various embodiments, the first location server 115 may send the unique token to the second location server 125, e.g., via an IP connection or other communication network, based on a pre-arranged agreement between the first and second location servers 115 and 125, for example. The second location server 125 creates a cache entry of the unique token to point to the address of the first location server 115, as discussed below with reference to block S313 of FIG. 3.

The first location server 115 may also include the unique token, as well as the domain address of the second location server 125, in the location URI that it creates in response to the request from the target device 111. For example, a representative location URI may appear as follows: http://validating.lis.carrier.com/unique.token, where validating.lis.carrier.com is the domain address of the second location server 125.

The first location server then returns the requested location URI to the target device 111 in block S213. In an embodiment, the first location server 115 takes no further action with respect to the location URI and/or determining the location of the target device 111 at this time.

Eventually, at block S214, the first location server 115 receives a location request from the second location server 125 querying the location of the target device 111. The location request includes the location URI previously generated by the location server 115 in block S212, which was provided to the second location server 125 by the application server 135 in response to a requirement for the location of the target device 111. The first location server 115 identifies the target device 111 in block S215 using the location URI from the location request. For example, when the location URI includes the unique token initially created by the first location server 115, as discussed above, the location request from the second server 125 includes the unique token. The first location server 115 is then able to consult its memory cache using the unique token as a key to determine the IP address and MAC address of the target device. Once the target device 111 has been identified, the first location server 115 performs a location determination algorithm in block S216 to calculate the location of the target device 111, as discussed above. The calculated location of the target device 111 is returned to the second location server 125 in block S217.

Referring now to FIG. 3, the second location server 125 receives a request for the location of the target device 111 in block S311. As discussed above, the request is received from the application server 135, for example, pursuant to the application 134 being executed by the application server 135, which requires the location of the target device 111. The request may be received by the second location server 125 via the Internet 130 or other communication network, such as dedicated trunks, VPN connections and the like, for example. The request includes the location URI generated by the first location server 115 and provided to the target device 111 in block S213 of FIG. 2. The target device 111 previously provided the location URI to the application 134 pursuant to execution of a location based service, and the application 134 dereferences the location URI by presenting it to the second location server 125.

The second location server 125 extracts the location URI from received location request in block S312 and identifies the first location server 115 using the extracted location URI in block S313. For example, when the location URI includes the unique token initially created by the first location server 115, as discussed above, the second server 125 extracts the unique token and consults its cache using the extracted unique token to identify the first location server 115 as the appropriate (asserting) location server to query.

In block S314, the second location server 125 sends a location request to the identified first location server 115, e.g., via an IP connection or other communication network, querying the first location server 115 for the location of the target device 111. The location request includes sufficient information as to allow location server 115 to identify target device 111. For example, the location request may include the unique token, as discussed above.

The second location server 125 waits for the first location server 115 to determine the location of the target device 111, as discussed with reference to block S216 of FIG. 2. In block S315, the second location server 125 receives the determined location of target device 111 from the first location server 115.

The second location server 125 then verifies the received location of the target device 111 in block S316 in order to confirm its accuracy. For example, the second location server 125 may confirm that the received location is in the geographic domain of the first location server 115, e.g., by comparing the received location with previously stored known boundaries of the first network 110 (serviced by the first location server 115). In another example, the second location server 125 may independently determine the location of the target device 111, and compare the received location from the first location server 115 with the independently determined location to determine whether the received location falls within a predetermined range of accuracy. When the determined location of the target device 111 falls outside the known boundaries or the predetermined range of accuracy, it may be assumed that the determined location is invalid.

When the received location of the target device 111 is verified (block S316: Yes), the second location server 125 provides the received location to the application server 135 at block S317, enabling the application 134 to proceed with execution of the corresponding location service. When the received location of the target device 111 is not verified (block S316: No), the second location server 125 generates an alternative location of the target device 111 using its own location determination processes in block S318 and provides the alternative location to the application server 135 at block S319. For example, when the target device 111 is no longer within the first network 110, or the first location server 115 is otherwise unable to provide a reasonably accurate location determination, the second location server 125 is still able to provide a location to the application server 135, even though it may not be as precise as what an accurate determination by the first location server 115 would otherwise produce. In an embodiment, the second location server 125 may determine the location of the target device 111 while waiting for the location as determined by the first location server 115, to decrease time delay in case the second location server 125 is unable to verify the validity of the location determined by the first location server 115 in block S316. In the event the second location server 125 is unable to verify the validity, an error message may be sent to the application server 135 notifying the application 134 of the inability to obtain the location of the target device 111.

Generally, according to various embodiments, a first LIS generates or obtains a location URI, which points to a (trusted) second LIS, for a target device residing in a network of the first LIS. The first LIS provides the location URI in response to a location request that points to second LIS. The second LIS is able to use the location URI, provided by a location based service application, to select the first LIS, and to use the location URI as a device identifier in a location request to the first LIS. The first LIS may take the location URI provided as a device identifier in the location request from the second LIS to determine and provide the location of the target device. The second LIS may validate that the location returned by the first LIS falls within the geographic domain serviced by the first LIS. The second LIS may also provide an alternative location if the location returned by the first LIS does not fall within the geographic domain serviced by the first LIS.

In various embodiments, location references may be served by location servers (e.g., asserting LIS and validating LIS) in a stateless fashion. This is accomplished by placing all of the information necessary to serve a request for the location of a target device in the location reference itself, such that a trusted location server is able to identify and communicate with an untrusted location server servicing the network in which the target device is located. For example, a validating LIS may take a first location URI from an asserting LIS, which is servicing the target device. The validating LIS generates a second location URI that does not require that the validating LIS maintain state in order to service it. In an embodiment, the first location URI served by the asserting LIS may also be stateless, although this is not necessary. Examples of creating location URIs that include embedded location context information and handling location requests using such location URIs are provided by U.S. patent application Ser. No. 12/411,883 and U.S. patent application Ser. No. 12/411,928, filed in the United States Patent and Trademark Office on Mar. 26, 2009, which are hereby incorporated by reference.

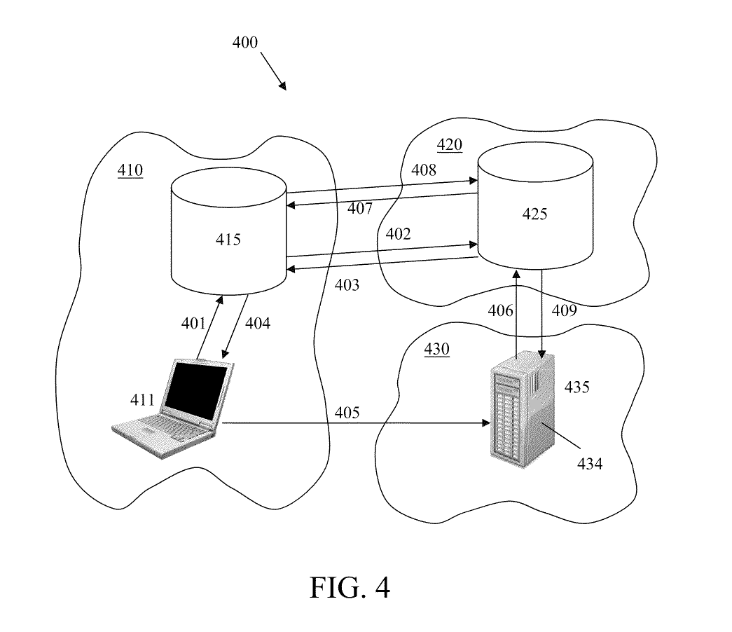

FIG. 4 is a functional block diagram illustrating a system for locating target devices in a communication network using a stateless implementation, according to a representative embodiment.

Referring to FIG. 4, telecommunications system 400 includes multiple networks serviced by corresponding location servers, indicated by first network 410 serviced by first location server 415 and second network 420 serviced by second location server 425. Representative target device 411 is shown residing in the first network 410. The target device 411 may be any type of device or terminal, configured for communicating through the telecommunications system 400, such as a cellular phone, a VoIP phone, a laptop computer, a PDA, a gaming device, television, appliance (e.g., refrigerator), or the like.

The target device 411 is depicted accessing a location based service, provided by application 434 running on application server 435 in third network 430. For purpose of discussion, it may be assumed that the first network 410, the second network 420 and the third network 430 are substantially the same as the first network 110, the second network 120 and the third network 130, respectively, discussed above with reference to FIG. 1. Therefore the descriptions of the first and second networks 410 and 420, as well as the corresponding first and second location servers 415 and 425, will not be repeated. Likewise, the description of the third network 43, as well as the corresponding application server 435 and application 434, will not be repeated.

Each of the first and second location servers 415 and 425 are configured to implement any of various types of location determination algorithms or processes for determining locations of target devices, such as target device 411, operating within one or both networks, as discussed above with reference to first and second location servers 115 and 125 of FIG. 1. Also, for purposes of discussion, it is assumed that the first network 410 implements location services that are not trusted by an external application, such as representative application 434 running on the application sever 435, while the second network 420 implements location services that are trusted by the application 434. In other words, there is no preexisting trust relationship between the application 434 and the first location server 415, but there is a preexisting trust relationship between the application 434 and the second location server 425.

According to various embodiments, the telecommunications system 400 provides a tandem trust relationship between the application server 435 and the first location server 415 through location server 425, which need not maintain state with respect to the relationship, so that the application server 435 may obtain location information with respect to the target device 411, even though location information provided directly by the location server 415 would otherwise be deemed untrustworthy. Various steps for establishing the tandem trust relationship in a stateless implementation, and providing location information to the application server 435 are depicted in FIG. 4 by numbered arrows, according to a representative embodiment.

In the depicted embodiment, the target device 411, while residing in the first network 410, requests a location reference from the first location server 415 in step 401. The request may be in response to execution of a location based service by the target device 411. Alternatively, the target device 411 may initiate such a request generally, e.g., whenever connecting to the first network 410 or after being connected over a predetermined period of time, in anticipation of the possibility of needing this information. Alternatively, the request for the location reference for the target device 411 may be initiated by a client other than the target device 411.

In response to the request, the first location server 415 generates a first location reference, and makes a request of the second location server 425 in step 402, including the first location reference. The first location reference may be a first location URI, for example. The first location reference may also be stateless, although this is not necessary. The first location reference includes embedded information that enable the first location server 415 subsequently to identify the target device 411, e.g., when the first location server 415 receives the first location reference from the second location server 425, as discussed below with reference to step 407. For example, identification information may include an ESN, an IP address, a MAC address or other unique identifier associated with the target device 411. In an embodiment, all or part of the embedded information is encrypted using a predetermined encryption technique and key, known by at least the first and second location servers 415, 425.

Also, in various embodiments, the first location reference may include additional context information, such as validating details and policy details, which may also be encrypted. For example, validating details may be any data used to ensure that identification and other information needed to initiate a location determination for the target device 411 still apply to the target device 411. Policy details may be any data indicating how and to whom the location formation may be provided, e.g., based on location context expiry times and other policy considerations. The policy details may be included directly, or by reference, for example, to a policy database. Including the policy details by reference enables changes to the policy details at the discretion of policy makers, even after the creation of the first location URI.

The second location server 425 generates a second location reference, which includes or otherwise refers to the first location reference provided by the first location server 415 in step 402. The second location reference may be a second location URI, for example, which includes the first location URI as embedded information. Because the second location reference includes all of the information needed to identify the first location server 415 and the target device 411, the second location URI is stateless. In other words, the second location server 425 does not need to maintain state or otherwise store data for identifying the first location server 415 and the target device 411, or for identifying the relationships among the first location server 415, the target device 411 and/or the first location reference.

In various embodiments, the first location reference and/or information that the second location server 425 uses in serving the second location reference may be encrypted in the second location reference using a predetermined encryption technique and key, known by at least the second location server 425. To prevent large location references being minted, relatively weak ciphers may be used to encrypt the embedded first location reference in the second location reference and/or to encrypt the embedded identification information in the first location reference. To prevent embedded information being leaked, a key replacement scheme may be used. For example, an unencrypted short identifier for selecting an encryption key may be included outside the encrypted portion of the second location reference and/or the first location reference. Notably, a key replacement period, plus the maximum possible lifetime of a location, should be significantly shorter than the time that it is expected to take to break the selected cipher. Accordingly, the cipher, the key replacement period and the location reference lifetime are selected together.

Any of various types of encryption may be implemented without departing from the scope of the present teachings. One example includes using a 128 bit variant of Advanced Encryption Standard (AES), along with a 32-bit cyclic redundancy check (CRC), enclosed in the encrypted portion of the location reference (e.g., token or location URI) to ensure that the contents cannot be altered. Use of the CRC prevents an attacker from tampering with the contents of the location resource, which may be otherwise possible even when the contents are encrypted. The key identifier may be sent in the clear, as discussed above, to allow keys to be rotated and the cipher to be changed. An illustrative structure may appear as follows:

```
AES {
  Identification information (IP address, MAC, location URI, etc.)
  Other state (timestamps, etc.)
  CRC for other encrypted data
}
```

The second location server 425 sends the second location reference to the first location server 415 in step 403. The first location server 415 then returns the second location reference to the target device 411 in step 404, satisfying the initial request for a location reference sent by the target device 411 in step 401.

In various embodiments, the first location server 415 may include an expiration time for the first location reference, although the expiration time is not necessarily provided to the second location server 425. Likewise, the second location server 425 may include a separate expiration time for the second location reference. This prevents the first location server 415 from gaining an indefinitely valid second location reference. Thus, there may be two separate expiration times, separately enforced by the first location server 415 and the second location server 425. Alternatively, in an embodiment, the first location server 415 may mint the first location reference with a first expiration time, and request the second location reference from the second location server 425 using the first location reference as input, as discussed above. The second location server 425 provides the second location reference with a second expiration time. The first location server 415 then provides the target device 411 with the second location reference with an expiration time set to the lesser of the first and second expiration times.

After receiving the second location reference from the first location server 415, the target device 411 conveys the second location reference to the application server 435 in step 405. For example, the target device 411 may send the second location reference in reply to a request for the location reference by the application 434. Alternatively, the target device 411 may automatically provide the second location reference to the application 434 upon initiating the corresponding location based service.

In step 406, the application 434 requests the location of the target device 411 from the second location server 425 using the second location reference (which identifies the second location server 425) provided by the target device 411. As stated above, application 434 considers the location service implemented by the second location server 425 a trusted service. The second location server 425 receives the request from the application server 435, and extracts the first location reference, along with other data, from the second location reference. When the first location reference is encrypted, the second location server 425 first decrypts the extracted first location reference using the appropriate key, as would be apparent to one of ordinary skill in the art. The second location server 425 is able to identify the first location server 415 using the extracted (and decrypted) first location reference.

In step 407, the second location server 425 makes a request to the first location server 415 using the extracted first location reference (or information extracted from the second location reference), querying the location of the target device 411. Notably, the second location server 425 may be servicing location servers (e.g., asserting LISs) from enterprise networks in addition to the first network 410. The first location server 415 receives the location request from the second location server 425, and uses the first location reference to identify the target device 411, e.g., from among multiple mobile devices operating within the first network 410. The first location server 415 then determines the location of the identified target device 411 by performing an associated location determination algorithm, discussed above with reference to FIG. 1.

The determined location is provided to the second location server 425 in step 408. The second location server 425 then provides the determined location of the target device 411 to the application server 435 in step 409, which uses the determined location to complete execution of the application 434.

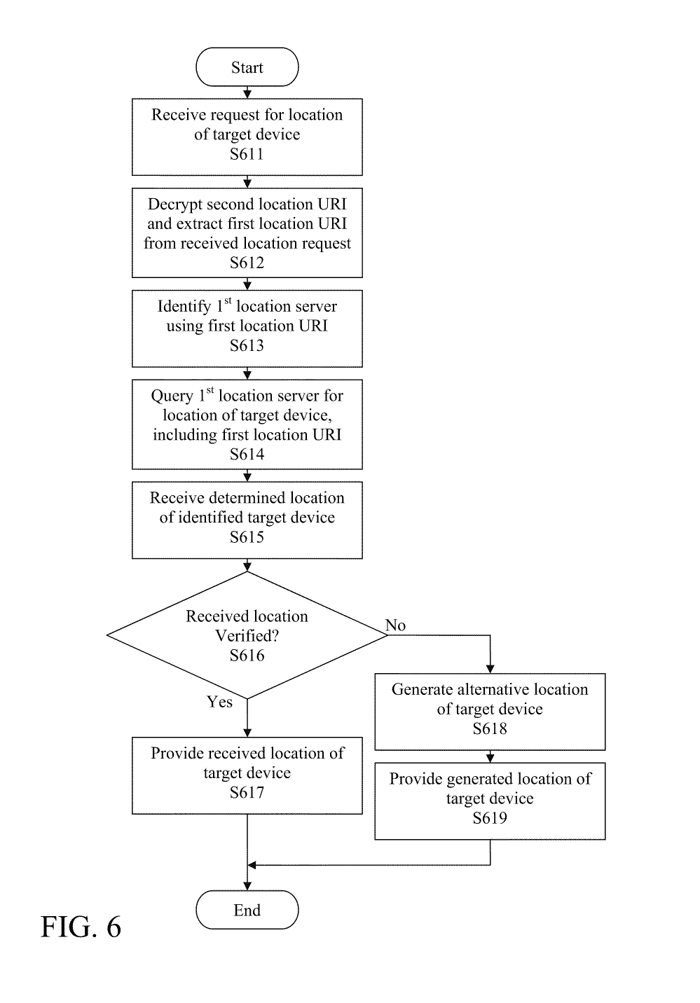

In various embodiments, the second location server 425 may first validate the location of the target device 411 before sending the location on to the application server 435, as discussed further with reference to FIG. 6, below. When the second location server 425 is unable to validate the location, it may separately determine the location of the identified target device 411 by performing its associated location determination algorithm, which is then provided to the application server 435 in step 409.

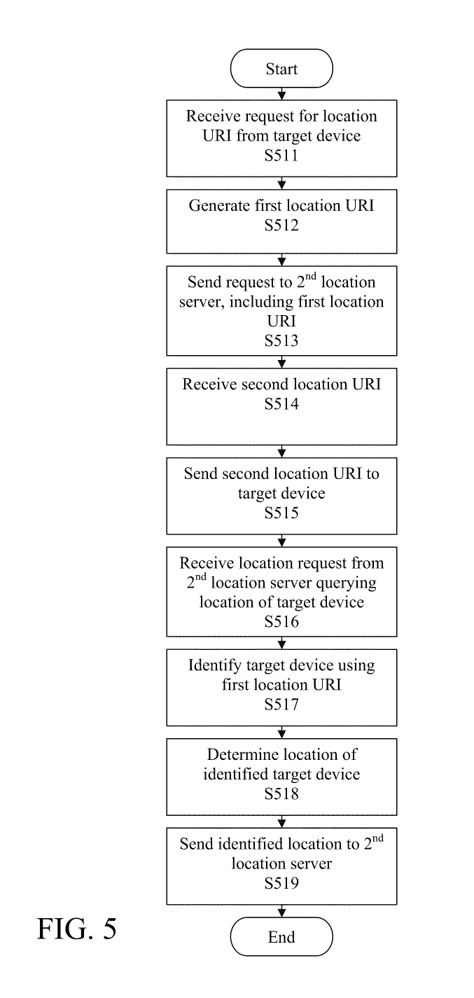

The stateless location determination process using tandem trust relationships discussed above with reference to FIG. 4 may be implemented according to complementary algorithms executable by the first and second location servers 415 and 425, respectively. For example, FIG. 5 is a flowchart illustrating a method implemented by the first location server 415 in the first network 410 for locating the target device 411, and FIG. 6 is a flowchart illustrating a method implemented by the second location server 425 in the second network 420 for locating the target device 411, according to representative embodiments including stateless implementation. For purposes of description, the first and second location references are assumed to be location URIs, although various other types of location reference may be incorporated, as discussed above.

Referring to FIG. 5, the first location server 415, e.g., the asserting LIS, receives a request for a location URI from the target device 411 in block S411, where the target device 411 is operating within the first network 410. The target device 411 has a MAC address and has been allocated a dynamic IP address in the first network 410. The request is received through the first network 410, which may be any type of wired or wireless IP network in the present example.

In response, the first location server 415 generates or otherwise obtains a first location URI in block S512. The first location URI includes sufficient information to enable a location server in another domain (e.g., the second location server 425) to identify the first location server 415 and to enable the first location server 415 subsequently to identify the target device 411. For example, the first location server 415 may identify the IP address of the target device 411 from the request received in block S511, and determine the MAC address of the target device 411 based on the IP address using any of a variety of determination techniques, as would be apparent to one of ordinary skill in the art. The first location server 415 may include the IP address and/or MAC address of the target device in the first location URI, as well as the domain name and/or IP address of the first location server 415, the protocol to be used to contact the first location server 415, and any other information required by the protocol (e.g., TCP port, etc.). However, various other information for identifying the first location server 415 and/or the target device 411 may be included without departing from the scope of the present teachings. Also, in various embodiments, the information included in the first location URI may be encrypted.

The first location server 415 sends a request for a location URI to the second location server 425, e.g., the validating LIS, in block S513, where the request includes the first location URI. For example, the first location URI may be included in the request to the second location server 425 by populating the <uri> parameter described by Winterbottom et al. in Internet-Draft, “Use of Device Identity in HTTP-Enabled Location Delivery (HELD), draft-ietf-geopriv-held-identity-extensions-04 (Jun. 21, 2010) (hereinafter, “HELD Draft”), the contents of which are hereby incorporated by reference. More particularly, the HELD Draft provides the following example of a request for location information, including the <uri> parameter, that refers to a single device:

<device xmlns=“urn:ietf:params:xml:ns:geopriv:held:id”>
<uri>sip:user@example.net;gr=kjh29x97us97d</uri>
</device>

The first location server 415 and the second location server 425 must have a common understanding of the semantics implied by use of the first location URI. Of course, other techniques for including the first location URI and/or identification information embedded in the first location URI in the request may be incorporated without departing from the scope of the present teachings.

In block S514, the first location server 415 receives a second location URI from the second location server 425 in response to the request. The second location URI includes the first location URI as embedded information. For example, the second location URI includes a path or query component containing embedded information, including the first location URI, which the second location server 425 uses in serving the second location URI. The embedded information may be encrypted, and thus included in an encrypted portion or encrypted string of the path or query component in the second location URI. In an embodiment, the second location server 425 knows the identity of all likely asserting location server (e.g., including the first location server 415) instances, and thus assigns each an identifier. The assigned identifier can be included in the encrypted portion of the second location URI generated by the second location server 425 to identify the first location server 415, e.g., in place of the scheme, host and port portions of the second location URI, thus reducing the amount of data that needs to be encrypted.

The first location server 415 then returns the second location URI to the target device 411 in block S515. In an embodiment, the first location server 415 takes no further action with respect to the first or second location URIs and/or determining the location of the target device 411 at this time. Meanwhile, the target device 411 conveys the second location URI to the application server 435, e.g., in reply to a request for a location URI by the application 434. The application server 435 sends second location URI to the (trusted) second location server 425 to request the location of the target device 411, as discussed above with reference to steps 405 and 406 of FIG. 4. The initial handling of the second location URI by the second location server 425 is discussed below with reference to blocks S611-S615 of FIG. 6.

Eventually, at block S516, the first location server 415 receives a location request from the second location server 425 querying the location of the target device 411. The location request includes the first location URI previously generated by the location server 415 in block S512, which was provided to the second location server 425 by the application server 435 in response to a requirement for the location of the target device 411. The first location server 415 decrypts the first location URI (if necessary) and extracts the embedded identification information in order to identify the target device 411 in block S517. Once the target device 411 has been identified, the first location server 415 performs a location determination algorithm in block S518, e.g., using wiremap, packet tracing and/or other techniques, to calculate the location of the target device 411, as discussed above. The calculated location of the target device 411 is returned to the second location server 425 in block S519.

As mentioned above, FIG. 6 is a flowchart illustrating a method implemented by the second first location server 425 in the second network 420 for locating the target device 411, according to representative embodiments including stateless implementation. Referring to FIG. 6, the second location server 425, e.g., the validating LIS, receives a request for the location of the target device 411 from the application server 435 in block S611. More particularly, the application 434 makes a request including the second location URI received from the target device 411, where the second location URI identifies the second location server 424.

In block S612, the second location server 425 decrypts (if necessary) the encrypted string or data of the path or query component in the second location URI, extracting the first location URI along with other embedded information. For example, in order to decrypt the encrypted data, the second location server 425 may extract an unencrypted short identifier that identifies an encryption key from the second location URI, extract an encrypted sequence from the second location reference, and decrypt the encrypted sequence using the extracted encryption key to obtain decrypted data. A checksum or hash of the decrypted data may be validated to check for modification of the second location URI. The first location URI is extracted from the decrypted data. The second location server 425 identifies the first location server 415 in block S613 using the extracted first location URI, which refers to and otherwise identifies the first location server 415, as well as the target device 411. In block S614, the second location server 425 makes a request including the first location URI to the first location server 415 for the location of the target device 411.

After the first location server 425 has determined the location of the target 411, as discussed above with reference to blocks S516-S519, the second location server receives the determined location from the first location server 415 in block S615. The second location server 425 then verifies the received location of the target device 411 in block S616 in order to confirm its accuracy. For example, the second location server 425 may confirm that the received location is in the geographic domain of the first location server 415, e.g., by comparing the received location with previously stored known boundaries of the first network 410 or by comparing the received location with a location determined independently by the second location server 425. When the determined location of the target device 411 falls outside the known boundaries, it may be assumed that the determined location is invalid.

When the received location of the target device 411 is verified (block S616: Yes), the second location server 425 provides the received location to the application server 435 at block S617, enabling the application 434 to proceed with execution of the corresponding location service. When the received location of the target device 411 is not verified (block S616: No), the second location server 425 generates an alternative location of the target device 411 using its own location determination processes in block S618 and provides the alternative location to the application server 435 at block S619. For example, when the target device 411 is no longer within the first network 410, or the first location server 415 is otherwise unable to provide a reasonably accurate location determination, the second location server 425 is still able to provide a location to the application server 435, even though it may not be as precise as what an accurate determination by the first location server 415 would otherwise produce. In an embodiment, the second location server 425 may determine the location of the target device 411 while waiting for the location as determined by the first location server 415, to decrease time delay in case the second location server 425 is unable to verify the validity of the location determined by the first location server 415 in block S619. In the event the second location server 425 is unable to verify the validity, an error message may be sent to the application server 435 notifying the application 434 of the inability to obtain the location of the target device 411.

Generally, according to various embodiments, a first LIS generates a first location URI including embedded identification information for a target device residing in a network of the first LIS. The first LIS provides the first location URI to a second LIS, which embeds the first location URI in an encrypted portion of a second location URI, generated by the second LIS. The second LIS provides the second location URI to the first LIS, which provides the second location URI to the target device. The second LIS stores no information, and otherwise does not maintain state, in regard to the first or second location URIs, the first LIS and/or the identification of the target device.

Subsequently, the second LIS receives the second location URI from a location based service application seeking the location of the target device, and extracts and decrypts the first location URI from the second location URI. The second LIS requests the location of the target device by sending the first location URI to the first LIS, which is identified by the extracted first location URI. The first LIS identifies the target device using the first location URI, and returns the location of the target device to the second LIS. The second LIS may validate that the location returned by the first LIS falls within the geographic domain serviced by the first LIS. The second LIS may also provide an alternative location if the location returned by the first LIS does not fall within the geographic domain serviced by the first LIS.

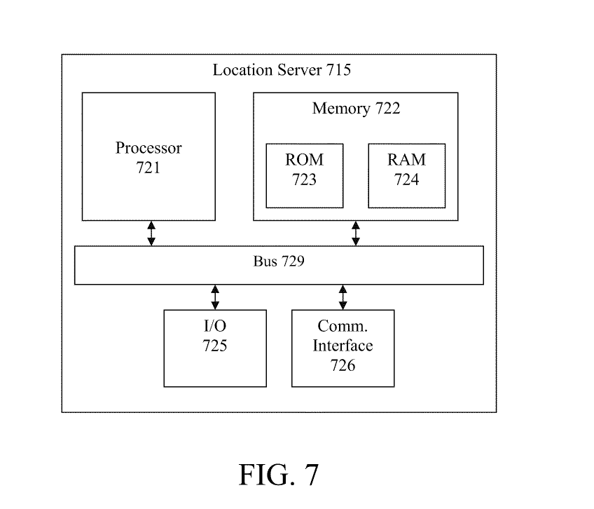

FIG. 7 is a functional block diagram showing an illustrative server 715, such as the first location severs 115, 415 or second location servers 125, 425, that executes all or a portion of a process for determining the location of a target device using tandem trust relationships, according to a representative embodiment. Although the server 715 is shown and discussed in detail, it is understood that other servers in the telecommunication system 100 and/or the target device 111 of FIG. 1 or in the telecommunication system 400 and/or the target device 411 of FIG. 4 may be configured in a similar manner as the server 715, at least with respect to processing and storage functionality.

The various “parts” shown in the server 715 may be physically implemented using a software-controlled microprocessor, e.g., processor 721, hard-wired logic circuits, firmware, or a combination thereof. Also, while the parts are functionally segregated in the server 715 for explanation purposes, they may be combined variously in any physical implementation.

In the depicted embodiment, the server 715 includes processor 721, memory 722, bus 729 and various interfaces 725-726. The processor 721 is configured to execute one or more logical or mathematical algorithms, including the location determination process of the embodiments described herein, in conjunction with the memory 722, as well as basic functionality for executing and/or controlling location determination processes for locating target devices. The processor 721 may be constructed of any combination of hardware, firmware or software architectures, and include its own memory (e.g., nonvolatile memory) for storing executable software/firmware executable code that allows it to perform the various functions. Alternatively, the executable code may be stored in designated memory locations within memory 722, discussed below. In an embodiment, the processor 721 may be a central processing unit (CPU), for example, executing an operating system, such as Windows operating systems available from Microsoft Corporation, NetWare operating system available from Novell, Inc., or Unix operating system available from Sun Microsystems, Inc. The operating system controls execution of other programs of the location server 715.

The memory 722 may be any number, type and combination of nonvolatile read only memory (ROM) 723 and volatile random access memory (RAM) 724, and stores various types of information, such as computer programs and software algorithms executable by the processor 721 (and/or other components), e.g., to perform location determination processes of the embodiments described herein. As generally indicated by ROM 723 and RAM 724, the memory 722 may include any number, type and combination of tangible computer readable storage media, such as a disk drive, an electrically programmable read-only memory (EPROM), an electrically erasable and programmable read only memory (EEPROM), a CD, a DVD, a universal serial bus (USB) drive, and the like. Further, the memory 722 may store the predetermined boundaries one or more enterprise networks, as discussed above.

Further, as discussed above, messages are received from various other components (e.g., first location servers 115, 415, second location servers 125, 425, target devices 111, 411, application servers 135, 435) through communication interface 726, and communicated to the processor 721 and/or the memory 722 via bus 729. The type, number and arrangement of the network interfaces may vary without departing from the scope of the present teachings.

In an embodiment, a user and/or other computers may interact with the server 715 using various input device(s) through I/O interface 725. The input devices may include a keyboard, key pad, a track ball, a mouse, a touch pad or touch-sensitive display, and the like. Also, various information may be displayed on a display through a display interface (not shown), which may include any type of graphical user interface (GUI).

In various embodiments, the process steps depicted FIGS. 2-3 and 5-6 may be incorporated within one or more processing modules of a device, such as the first location servers 115, 415 and/or the second location servers 125, 425, respectively. However, the modules may be executable by any other server, computer or node programmable to determine all or a portion of the location determination process according to the various embodiments, without departing from the scope of the present teachings. The modules may be implemented as any combination of software, hard-wired logic circuits and/or firmware configured to perform the designated operations. Software modules, in particular, may include source code written in any of a variety of computing languages, such as C++, C# or Java, and are stored on tangible computer readable storage media, such the computer readable storage media discussed above with respect to memory 722, for example.

The identity and functionality of the modules may vary, without departing from the scope of the present teachings. For example, referring to FIG. 2, blocks S211 and S212 may be incorporated within a location URI generation module, blocks S213, S214 and S217 may be incorporated within a server communication module, and blocks S215 and S216 may be incorporated within a target device location determination module. Also, for example, referring to FIG. 3, block S311 may be incorporated within an application interface module, blocks S312 and S313 may be incorporated within a location URI extraction module, blocks S314 and S315 may be incorporated within a server communication module, and blocks S316 to S319 may be incorporated within a target device location verification module. Of course, the number and/or identities of the modules, as well as the combinations of steps included in each, may vary without departing from the scope of the present teachings.

Similarly, referring to FIG. 5, blocks S511 and S512 may be incorporated within a first location URI generation module, blocks S513-S516 and S517 may be incorporated within a server communication module, and blocks S517 and S518 may be incorporated within a target device location determination module. Also, for example, referring to FIG. 6, block S611 may be incorporated within an application interface module, blocks S612 and S613 may be incorporated within a location URI extraction module, blocks S614 and S615 may be incorporated within a server communication module, and blocks S616 to S619 may be incorporated within a target device location verification module. Of course, the number and/or identities of the modules, as well as the combinations of steps included in each, may vary without departing from the scope of the present teachings.

While specific embodiments are disclosed herein, many variations are possible, which remain within the concept and scope of the invention. Such variations would become clear after inspection of the specification, drawings and claims herein. The invention therefore is not to be restricted except within the scope of the appended claims.

What is claimed is:

1. A method of providing a location of a target device, the method comprising:
receiving a first location reference request from the target device at a first location server;
generating a first location reference in response to the first request;
including the first location reference in a second location reference request to a second location server, the second location server generating a stateless second location reference in response to the second request, the second location reference being embedded in the second location reference;
receiving the second location reference from the second location server; and
providing the second location reference to the target device to be provided to an application requesting location information of the target device from the second location server, wherein the stateless second location reference includes information necessary for the second location server to serve a request for the location of the target device without maintaining state specific to the location reference.

2. The method of claim 1, wherein the second location reference comprises a second location URI.

3. The method of claim 2, wherein the second location URI comprises a component having an encrypted string containing encrypted information to be used in serving the second location URI.

4. The method of claim 3, wherein the component further comprises an unencrypted key identifier for selecting an encryption key.

5. The method of claim 3, wherein the encrypted information comprises the first location reference.

6. The method of claim 5, wherein the encrypted information further comprises an access control policy.

7. The method of claim 2, wherein the first location reference is stateless.

8. The method of claim 1, wherein including the first location reference in the second location reference comprises populating a parameter of the second location reference with the first location reference.

9. The method of claim 1, further comprising:
receiving a query from the second location server requesting the location of the target device, the query including the first location reference;
identifying the target device using the first location reference; and
determining the location of the target device in response to the query.

10. The method of claim 9, further comprising:
providing the determined location of the target device to the second location server, which provides the determined location to the application.

11. The method of claim 9, wherein the first location server has no preexisting trust relationship with the application, and the second location server has a preexisting trust relationship with the application.

12. A method of providing a location of a target device to an application implementing a location based service, the method comprising:
receiving a request for a location of the target device from the application at a second location server, the request including a stateless second location reference that includes an embedded first location reference identifying the target device and a first location server that generated the location reference;
sending a request to the first location server identified in the first location reference for the location of the target device, the request including the first location reference, which is used by the first location server for identifying the target device and determining the location of the target device;
receiving the determined location of the target device from the first location server; and
providing the determined location of the target device to the application.

13. The method of claim 12, wherein the first and second location references comprise first and second uniform resource identifier (URIs), respectively.

14. The method of claim 12, wherein the embedded first location reference is encrypted.

15. The method of claim 14, further comprising:
decrypting the embedded first location reference before sending the request to the first location server for the location of the target device.

16. The method of claim 15, wherein decrypting the embedded first location reference comprises:
extracting an unencrypted short identifier that identifies an encryption key from the second location reference;
extracting an encrypted sequence from the second location reference;
decrypting the encrypted sequence using the extracted encryption key to obtain decrypted data;
validating a checksum or hash of the decrypted data to check for modification of the second location reference; and
extracting the first location reference from the decrypted data.

17. The method of claim 12, further comprising:
validating the determined location of the target device before providing the determined location to the application.

18. The method of claim 17, wherein validating the determined location of the target device comprises:
comparing the determined location to known boundaries of a first network that includes the first location server; and
verifying the determined location of the target device when the determined location is within the known boundaries.

19. The method of claim 17, wherein validating the determined location of the target device comprises:
comparing the determined location of the target device to a location of the target device separately determined by the second location server; and
verifying the determined location of the target device when the determined location is within a predetermined range of the location determined by the second location server.

20. A system for retrieving a location of a target device, the system comprising:
an asserting location information server (LIS) in an enterprise network, the asserting LIS providing a first location uniform resource identifier (URI) to a validating LIS in response to a request for a location URI from a target device in the enterprise network, receiving a stateless second location URI from the validating LIS including the first location URI, and providing the second location URI to the target device, wherein the target device sends the second location URI to an Internet application providing a location based service to the target device; and
the validating LIS in a carrier network, the validating LIS receiving the second location URI from the Internet application in a request for the location of the target device, extracting the first location URI from the second location URI, providing the first location URI in a request to the asserting LIS for the location of the target device, receiving the location of the target device determined by the asserting LIS, and providing the received location of the target device to the Internet application,
wherein the asserting LIS does not have a trust relationship with the Internet application.
